(19) United States
(12) Patent Application Publication
(10) Pub. No.: US 2024/0348075 A1
(43) Pub. Date: Oct. 17, 2024

(54) SEQUENCE CURRENT CHARGING OF COMPOSITE LITHIUM METAL BATTERY CELLS

(71) Applicant: Soelect Inc., Greensboro, NC (US)

(72) Inventors: Sungjin Cho, Summerfield, NC (US); Anthony T Montoya, High Point, NC (US)

(21) Appl. No.: 18/635,636

(22) Filed: Apr. 15, 2024

Related U.S. Application Data
(60) Provisional application No. 63/459,482, filed on Apr. 14, 2023.

(51) Int. Cl. H02J 7/00; H01M 10/0525; H01M 10/44

(52) U.S. Cl. CPC H02J 7/0071; H01M 10/0525; H01M 10/44

(57) ABSTRACT

A method for sequence current charging a composite lithium metal battery cell is disclosed. In one example, the method includes applying, to a composite lithium metal battery cell for an initial predefined time period, a charging current that is equal to a first portion of a full charging current, wherein the composite lithium metal battery cell includes a composite lithium metal anode; adjusting, after the initial predefined time period, the charging current applied to the composite lithium metal battery cell to a level equal to a second portion of the full charging current for a second predefined time period, wherein the charging current is immediately adjusted at an end of the initial predefined time period without affording the composite lithium metal battery cell any rest or relaxation period; and adjusting, after the second predefined time period, the charging current applied to the composite lithium metal battery cell to a level equal to a third portion of the full charging current until an expiration of a target charging time, wherein the charging current is immediately adjusted at an end of the second predefined time period without affording the composite lithium metal battery cell any rest or relaxation period.

### CROSS REFERENCE TO RELATED APPLICATIONS

This application claims priority to U.S. Application No. 63/459,482, filed Apr. 14, 2023, the disclosure and content of which is incorporated by reference herein in its entirety.

### TECHNICAL FIELD

The disclosed subject matter herein pertains to the charging of lithium metal batteries comprising composite lithium metal anodes generally, and more particularly pertains to sequence current charging of composite lithium metal battery cells.

### BACKGROUND

Lithium metal is one of the most promising high energy and high power anode materials for use in the manufacture of rechargeable battery cells required by future electronic devices, such as electric vehicles, IT electronics, and many others. However, lithium metal is a chemically hydrophobic material and difficult to wet with the liquid electrolytes commonly used in lithium metal batteries. Lithium metal is also susceptible to the formation of dendrites, i.e., the heterogenous growth of metallic needles, which typically occurs after repeated cycling. Dendrite formation is also more problematic at higher charging rates, as the rate of lithium plating on the anode surface exceeds the rate of lithium ion diffusion into the bulk material of the anode. Notably, dendrite formation limits the amount of available active lithium in the battery cell, which can reduce the capacity, efficiency, and lifetime of the battery cell. Safety is also a significant concern since the battery cell can experience a short circuit if the dendrites forming on the anode element puncture the separator and establish physical contact with the cathode. Many approaches have been taken to limit the effects of dendrite formation in a battery cell, including various attempts to modify the anode surface or separator, modifying the formulation of the artificial solid electrolyte interphase (SEI), experimenting with different electrolyte additives, and/or using solid state electrolyte materials.

### SUMMARY

In one embodiment, the disclosed subject matter relates to a method for sequence current charging a composite lithium metal battery cell. In particular, the method includes applying, to a composite lithium metal battery cell for an initial predefined time period, a charging current that is equal to a first portion of a full charging current, wherein the composite lithium metal battery cell includes a composite lithium metal anode; adjusting, after the initial predefined time period, the charging current applied to the composite lithium metal battery cell to a level equal to a second portion of a full charging current for a second predefined time period, wherein the charging current is immediately modified at an end of the initial predefined time period without affording the composite lithium metal battery cell any rest or relaxation period; and adjusting, after the second predefined time period, the charging current applied to the composite lithium metal battery cell to a level equal to a third portion of the full charging current until an expiration of a target charging time, wherein the charging current is immediately modified at an end of the second predefined time period without affording the composite lithium metal battery cell any rest or relaxation period.

In one embodiment, the disclosed subject matter relates to a method for sequence current charging a composite lithium metal battery cell. In particular, the method includes applying, during a first sequence current charging time period, a first charging current to the composite lithium metal battery cell, wherein the first charging current is a fraction of a full charging current to be applied to the battery cell over a full target charging time period, wherein the composite lithium metal battery cell includes a composite lithium metal anode; applying, during a second sequence current charging time period, a second charging current to the composite lithium metal battery cell, wherein the second charging current is greater or less than the first charging current and less that the full charging current and wherein the second charging current is immediately applied at the start of the second predefined time period without affording the composite lithium metal battery cell any rest or relaxation period; and applying, during a third sequence current charging time period, a third charging current to the composite lithium metal battery cell, wherein the third charging current is greater or less than the second charging current and wherein the third charging current is immediately applied at the start of the third predefined time period without affording the composite lithium metal battery cell any rest or relaxation period.

In one embodiment, the disclosed subject matter relates to a battery charger device that is configured to apply a charging current to a composite lithium metal battery cell. For example, the device includes processing circuitry and a memory coupled to the processing circuitry, wherein the memory comprises computer readable program instructions that, when executed by the processing circuitry, cause the control system to perform operations to: apply, during a first sequence current charging time period, a first charging current to the composite lithium metal battery cell, wherein the first charging current is a fraction of a full charging current to be applied to the battery cell over a full target charging time period, wherein the composite lithium metal battery cell includes a composite lithium metal anode; apply, during a second sequence current charging time period, a second charging current to the composite lithium metal battery cell, wherein the second charging current is greater or less than the first charging current and less that the full charging current and wherein the second charging current is immediately applied at the start of the second predefined time period without affording the composite lithium metal battery cell any rest or relaxation period; and apply, during a third sequence current charging time period, a third charging current to the composite lithium metal battery cell, wherein the third charging current is greater or less than the second charging current and wherein the third charging current is immediately applied at the start of the third predefined time period without affording the composite lithium metal battery cell any rest or relaxation period

The disclosed subject matter provides a number of technical benefits and advantages as related to charging of rechargeable batteries (e.g., composite lithium metal battery cells). Notably, by altering and/or adjusting the charging current in the manner(s) described herein, a battery cell's productive life span can be extended via inhibiting and/or slowing the growth of dendrites that commonly form within a lithium-ion battery cell. Further, since lower levels (i.e., less amps) of a charging current can be used with the disclosed sequencing method as compared to conventional constant current charging or dynamic/pulse charging methods (which typically use a charging current that exceeds a battery's normal “full charging current” threshold, the disclosed sequencing method provides a safer (e.g., less heat produced from charging) and less expensive (e.g., thinner wires and less energy are needed) battery charging solution.

As referred to herein, a “full charge” means charging a battery to its full capacity at a current rate of 1C. More specifically, the Current-Rate, or 1C, is the charging current rate that will completely charge a battery cell to its full capacity in one hour. For instance, using a battery with a capacity of 1000 mAh (milliampere-hours) as an example, a 1C charge current would be equal to 1000 mA (milliamperes) or 1 ampere. This means that if the battery is charged with a current of 1000 mA, it will reach its full capacity in one hour. Using the 1C charge rate is common in battery testing and specifications, thereby providing a standard reference point for evaluating charging performance and battery longevity. However, it is important to note while charging a battery at higher currents (e.g., above 1C), the use of such a higher charging rate may result in charging a battery cell faster, but will likely affect the battery's lifespan and performance to its detriment.

### BRIEF DESCRIPTION OF THE DRAWINGS

The accompanying drawings, which are included to provide a further understanding of the disclosure and are incorporated in and constitute a part of this application, illustrate certain non-limiting embodiments of the disclosed subject matter. In the drawings:

FIG. 1 is a graph diagram of an example increasing sequence charging current profile applied to a composite lithium metal battery cell according to some embodiments;

FIG. 2 is a graph diagram of an example sequence charging current profile applied to a composite lithium metal battery cell according to some embodiments;

FIG. 3 is a graph diagram of an example constant charging current profile applied to a composite lithium metal battery cell;

FIG. 4 is a graph diagram depicting a comparison of the specific capacity performance of a composite lithium metal battery subjected to constant current charging and sequence current charging according to some embodiments;

FIG. 5 is a graph diagram depicting a comparison of the capacity retention percentage performance of a composite lithium metal battery subjected to constant current charging and sequence current charging according to some embodiments;

FIG. 6 is a graph diagram depicting a comparison of the specific capacity performance of a composite lithium metal battery subjected to constant current charging and sequence current charging according to some embodiments;

FIG. 7 is a graph diagram depicting a comparison of the capacity retention percentage performance of a composite lithium metal battery subjected to constant current charging and sequence current charging according to some embodiments;

FIG. 8 is a graph diagram depicting a comparison of the specific capacity performance of a composite lithium metal battery and a bare lithium anode battery subjected to sequence current charging according to some embodiments;

FIG. 9 is a graph diagram depicting a comparison of the capacity retention percentage performance of a composite lithium metal battery and a bare lithium anode battery cell subjected to sequence current charging according to some embodiments;

FIG. 10 depicts a graph illustrating the charge-discharge voltage profiles for a composite lithium metal battery cell and a bare lithium anode battery cell subjected to sequence current charging according to some embodiments;

FIG. 11 depicts a table summarizing the charge capacity, discharge capacity, and coulombic effect for lithium metal battery cells subjected to constant current charging and sequence current charging according to some embodiments;

FIG. 12 is a flow chart illustrating an exemplary sequence current charging process according to some embodiments;

FIG. 13 is a flow chart illustrating another exemplary sequence current charging process according to some embodiments and

FIG. 14 is a block diagram of an exemplary battery charging device according to some embodiments.

### DETAILED DESCRIPTION

Various exemplary embodiments of the present disclosure are described below. Use of the term “exemplary” means illustrative or by way of example only, and any reference herein to “the disclosure” is not intended to restrict or limit the disclosure to exact features or step of any one or more of the exemplary embodiments disclosed in the present specification. References to “exemplary embodiment”, “one embodiment”, “an embodiment”, “various embodiments”, and the like may indicate that the embodiment(s) of the disclosure so described may include a particular feature, structure, or characteristic, but not every embodiment necessarily incudes the particular feature, structure, or characteristic. Further, repeated use of the phrase “in one embodiment”, “in an exemplary embodiment”, or “in an alternative embodiment” do not necessarily refer to the same embodiment, although they may.

It is also noted that terms like “preferably”, “commonly”, and “typically” are not utilized herein to limit the scope of the disclosure or to imply that certain features are critical, essential, or even important to the structure or function of the disclosure. Rather, these terms are merely intended to highlight alternative or additional features that may or may not be utilized in a particular embodiment of the present disclosure.

The present disclosure is described more fully hereinafter with reference to the accompanying figures, in which one or more exemplary embodiments of the disclosure are shown. Like numbers used herein refer to like elements throughout. The disclosure may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limited as to the scope of the disclosure, and any and all equivalents thereof. Moreover, many embodiments such as adaptations, variations, modifications, and equivalent arrangements will be implicitly disclosed by the embodiments described herein and fall within the scope of the instant disclosure.

Although specific terms are employed herein, they are used in a generic and descriptive sense only and not for the purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. Where only one item is intended, the terms “one and only one”, “single”, or similar language is used. When used herein to join a list of items, the term “or” denotes at least one of the items but does not exclude a plurality of items of the list. Moreover, the disclosed subject matter is described herein as adjusting or altering a sequence charging current over different time periods. As used herein, the terms ‘adjusting’, ‘altering’, ‘changing’, and ‘modifying’ are intended to be synonymous with regard to the disclosed sequence charging current methods and processes.

For exemplary methods or processes of the disclosure, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present disclosure.

Additionally, any references to advantages, benefits, unexpected results, or operability of the present disclosure are not intended as an affirmation that the disclosure has previously been reduced to practice or that any testing has been performed. Likewise, unless stated otherwise, use of verbs in the past tense (present perfect or preterit) is not intended to indicate or imply that the disclosure has previously been reduced to practice or that any testing has been performed.

At present, constant current-constant voltage (CC-CV) charging is one of the most common protocols for charging commercial battery cells. While the CC-CV method is applied in many systems, it requires optimization of current and voltage cut-offs when fast charging. In contrast, the disclosed subject matter pertains to a method that utilizes a plurality of sequence current charging periods to vary the charging rate(s) to be applied to a composite lithium metal battery cell (e.g., a lithium-ion battery cell that includes a composite lithium metal anode). As used herein, a composite lithium metal battery cell may refer to a rechargeable battery cell that comprises a lithium metal based anode that has been modified to include one or more additional materials. For example, the anode may include a lithium metal anode that has been subjected to a roll-pressing and/or dry powder processing that introduces one or more particulate materials on the surface and/or throughout the thickness of the lithium metal component. For example, a particulate material may include any substance that can be used to enhance the operation and/or functionality of the lithium metal anode, such as mitigating dendrite growth, affording hydrophilic characteristics, affording lithophilic characteristics, and the like. Examples of particulate materials include lithium based salts. As used herein, a lithium metal anode may refer to an anode comprising of “pure lithium metal” or substantially pure lithium metal (e.g., at least 95% lithium metal by weight). Notably, the disclosed method provides similar fast charging times and improves the performance characteristics of the charged lithium-ion battery as compared to conventional CC-CV techniques. Moreover, the disclosed sequence current charging method aims to better control the lithium plating and stripping process of the cell's anode, thereby creating more evenly distributed lithium plating during cycling as well as limiting the changes to the anode surface roughness resulting from dendrite growth.

The disclosed sequence current charging process is designed to improve the performance of a battery cell comprising composite lithium metal anodes. As indicated above, the commonly used CC-CV process results in uncontrolled lithium dendrite growth as the battery cell experiences many charge-discharge cycles. The disclosed sequence current charging method varies the applied current during the charging cycle to better regulate ion mobility and achieve a more uniform lithium plating process. Charging the battery cell in this manner restricts the formation of large dendrites and reduces isolation of inactive lithium deposits, thereby preserving charging capacity and extending the lifetime of the battery cell. In addition to these performance benefits, the disclosed method does not drastically compromise the charging time and provides a better method for limiting heat generation within the cell.

In one example instance of using the disclosed method, a lithium-ion battery cell (e.g., a 2032 coin cell) that comprises a composite lithium metal anode (LiX), a NMC811 cathode, and 1 M LiPF6 in carbonate-based electrolyte (25:70:5 mixture of EC, DEC, FEC) was assembled under an argon atmosphere (e.g., in a sealed glove box) and subsequently charged using the disclosed sequence current charging protocol. Compared to a constant current-constant voltage protocol that applies a full current over a full target charge rate of “1C” (e.g., 1C charging is the rate the charging current produces a full charge in the battery cell in one hour), the sequence charging current instead starts at a fraction of the full current. Notably, the sequence charging current increases to the full current in a series/sequence of steps over the entire target charging time period (e.g., one hour).

In some cases, conventional constant current-constant voltage methods and pulse charging methods may apply a current that exceeds a battery's “full charge” threshold value in the pursuit of fast charging. However, applying excessive current to a lithium-ion battery, especially a lithium metal battery, significantly reduces its lifespan, as lithium metal dendrites grow drastically at the beginning of charging. It is noteworthy that the sequential current charging methods described herein do not exceed the battery's full charge threshold value at the beginning. Instead, they gradually increase and decrease the current in the charging protocol, ultimately diminishing lithium metal dendrite growth significantly. This approach leads to a notable extension of the battery's cycle life. Two aims of the disclosed sequence current charging protocol include controlling the ion mobility in the cell and achieving more uniform plating of lithium metal on the anode surface during charging.

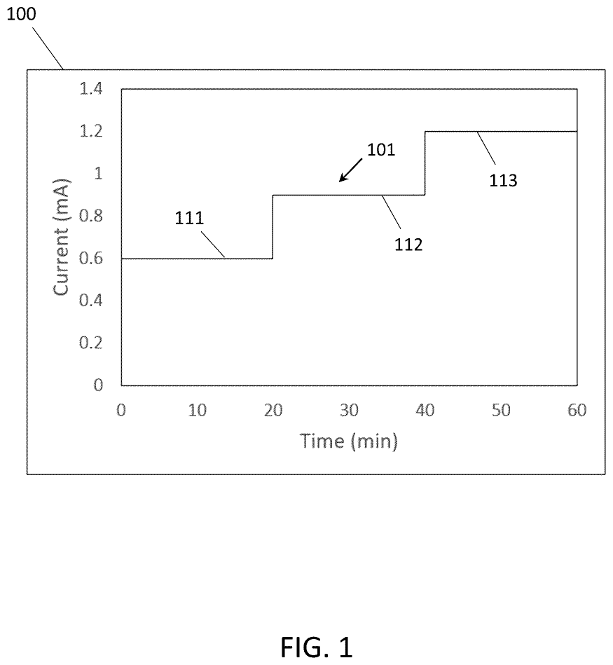

FIG. 1 is a graph 100 that includes a plot line 101 that illustrates the current charging profile of a battery cell over a target charge time period of one hour (i.e., 60 minutes as shown in the horizontal axis representing “time”). Notably, plot line 101 represents a plotted result of a disclosed sequence current charging protocol that comprises three (3) charging sequence steps: a first charging sequence step 111, a second charging sequence step 112, and a third charging sequence step 113. Although three charging sequence steps are shown in FIG. 1, additional charging sequence steps can be utilized without departing from the scope of the disclosed subject matter. As shown in FIG. 1, the first charging sequence step 111 is a “current step” that includes a 0.6 milliampere (mA) charging current that is applied to the battery cell over a first charging period, i.e., a 20 minute time period (or ⅓^{rd} of the full charging time). Similarly, the second charging sequence step 112 includes a 0.9 mA charging current applied to the battery cell over another 20 minutes. Notably, as indicated in FIG. 1, the second charging sequence step 112 is initiated immediately after the completion of the first charging sequence step 111, such that there is no (or minimal) rest between the two charging sequence steps 111 and 112. Likewise, the third charging sequence step 113 includes 1.2 mA charging current that is applied to the battery cell over the final 20 minutes immediately after the second charging sequence step has completed, such that such that there is no (or minimal) rest between the charging sequence steps 112 and 113. Although FIG. 1 illustrates the use of 0.6 mA, 0.9 mA, and 1.2 mA as the sequence charging current values, other sequence charging current values can be utilized without departing from the scope of the disclosed subject matter. For example, the first current step may run at 50% of the full current, the second current step may run at 75% of the full current, and the third current step may run at 100% of the full current (e.g., 0.5 mA, 0.75 mA, and 1.0 mA). Notably, as indicated above, the transition between each of the different charging sequence steps (e.g., switching to the second charging sequence current step from the first charging sequence step after the 20 minute charging period has expired) is conducted instantaneously without providing the charged battery cell any rest time or period of “relaxation”.

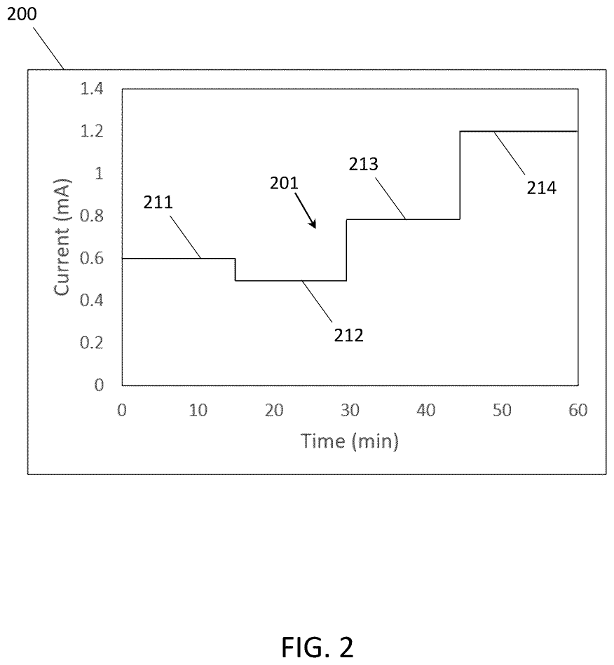

Although FIG. 1 depicts first charging sequence step 111, second charging sequence step 112, and third charging sequence step 113 increasing in a stepwise fashion, each of the second and third charging sequence steps (or other subsequent charging sequence steps) may be increased or decreased without departing from the scope of the disclosed subject matter. For example, FIG. 2 illustrates a second current charging profile 200 of a battery cell over a target charge time period of one hour (i.e., 60 minutes as shown in the horizontal axis representing “time”). As shown in FIG. 2, plot line 201 represents a plotted result of a disclosed sequence current charging protocol that comprises four (4) charging sequence steps: an initial first charging sequence step 211, a second charging sequence step 212 that has a current that is (slightly) less than first charging sequence step 211, a third charging sequence step 113 that has a current that is greater than both the first and second charging sequence steps 211 and 212, and a fourth charging sequence step 214 that is greater than the third charging sequence step. Although four charging sequence steps are shown in FIG. 2, additional charging sequence steps can be utilized without departing from the scope of the disclosed subject matter. Moreover, although FIG. 2 depicts the initial first charging sequence step 211 equal to 0.6 mA, the second charging sequence step 212 equal to 0.5 mA, the third charging sequence step 213 equal to 0.8 mA, and the fourth charging sequence step 214 equal to 1.2 mA, each of these charging sequence steps may be equal to a higher or lower current (as per the decision of the system operator).

As shown in FIG. 2, the first charging sequence step 211 is a current step that includes a 0.6 mA charging current that is applied to the battery cell over a first charging period, i.e., a 15 minute time period (or ¼th of the full charging time of one hour). Similarly, the second charging sequence step 212 includes a 0.5 mA charging current applied to the battery cell over another 15 minutes. Notably, as indicated in FIG. 2, the second charging sequence step 212 is initiated immediately after the completion of the first charging sequence step 211, such that there is no (or minimal) rest between the two charging sequence steps 211 and 212.

Furthermore, in FIG. 2, the second charging sequence step 212 is shown to be slightly lower than the first charging sequence step 211 (i.e., the second charging current may be a lower mA current than the initial/first charging current). Likewise, the third charging sequence 213 is depicted as being greater than the second charging sequence step 212, but in some embodiments may be lower than the second charging sequence 212 (i.e., the third charging current may be a lower mA current than the second charging current).

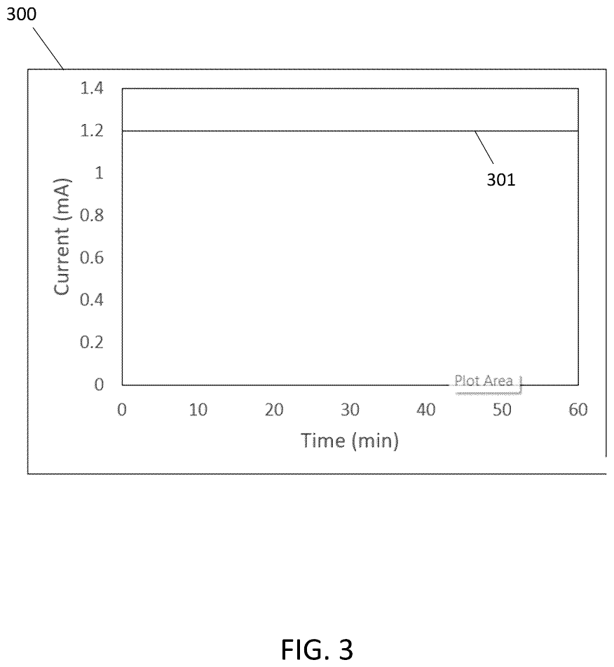

FIG. 3 is a graph 300 including a plot line 301 that depicts the current profile for the constant current method holding at 1.2 mA for the entire charging period (i.e., 1 hour). Notably, there are no “current steps” (i.e., plot line 301 is completely horizontal) or variation of the applied current when this charging protocol is utilized.

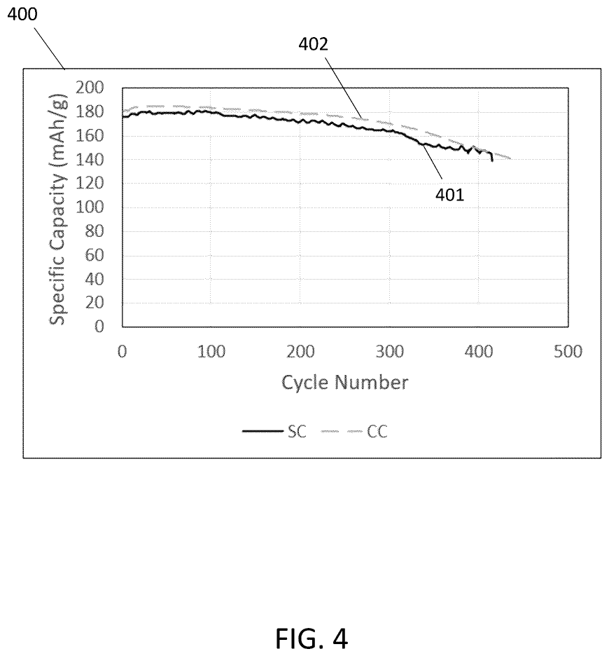

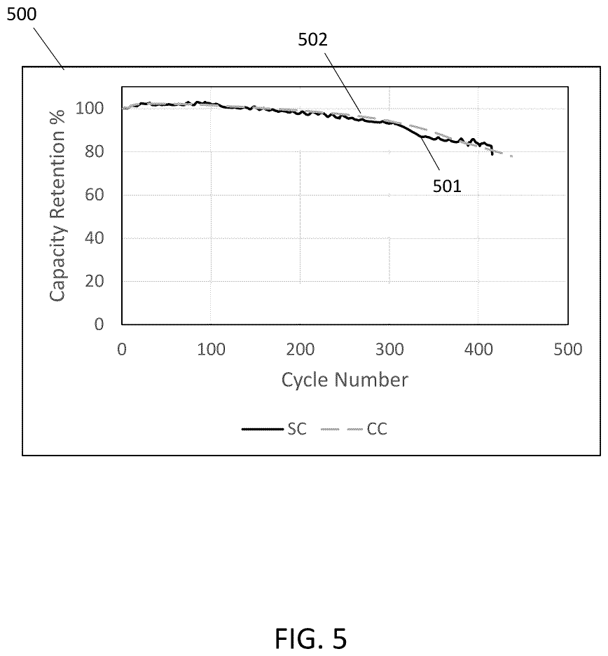

To evaluate the lifetime performance, battery cells made with either a composite anode or a 50 micrometer (μm) bare lithium metal anode were tested and compared. For example, two bare lithium metal battery cells (i.e., a lithium-ion battery that includes a bare lithium metal anode) were separately cycled at 1C charge and 1C discharge under a constant current protocol or the disclosed sequence current charging protocol. FIG. 4 illustrates a graph 400 that includes a first plot line 401 that depicts the discharge capacity performance of a bare lithium metal battery subjected to the disclosed sequence current charging protocol over long term cycling and a second plot line 402 that depicts the discharge capacity performance of a bare lithium metal battery subjected to the constant current protocol over long term cycling. Similarly, FIG. 5 illustrates a graph 500 that includes a first plot line 501 that depicts the percent capacity retention performance of a bare lithium metal battery subjected to the disclosed sequence current charging protocol over long term cycling and a second plot line 502 that depicts the percent capacity retention performance of a bare lithium metal battery subjected to the constant current protocol over long term cycling. FIGS. 4 and 5 indicate that charging the bare lithium metal battery cell under the sequence current charging protocol showed a minimal reduction in capacity compared to the constant current protocol. Notably, both methods exhibited near identical capacity retention for over 400 charge-discharge cycles, after which the battery cells reached an end-of-life state below 80% capacity retention.

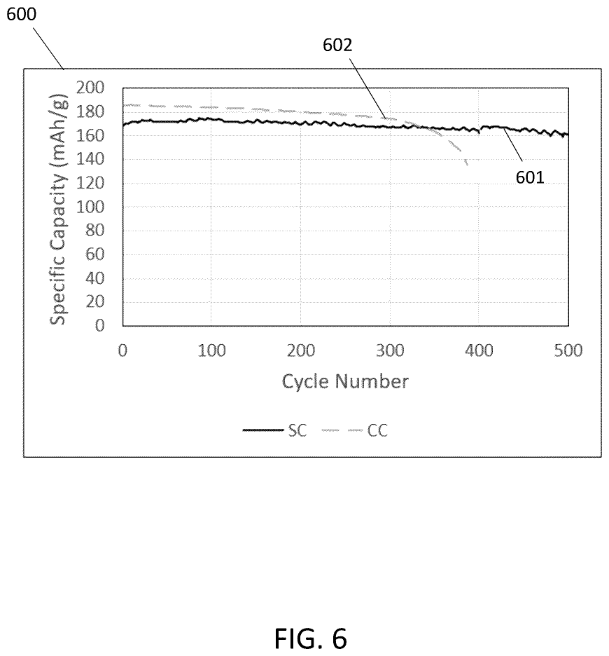

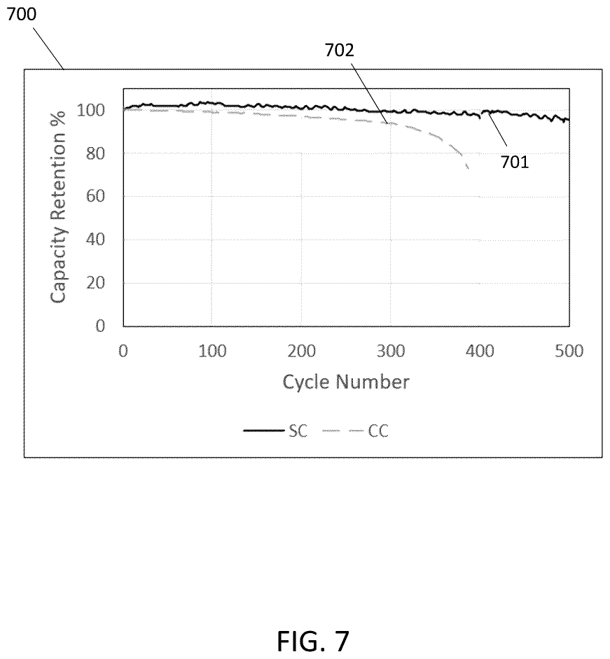

FIGS. 6 and 7 show the discharge capacity and percentage capacity retention respectively for the composite lithium metal battery cell over long term cycling using constant current and sequencing current methods. Specifically, FIG. 6 illustrates a graph 600 that includes a first plot line 601 that depicts the discharge capacity performance of a composite lithium metal battery cell subjected to the disclosed sequence current charging protocol over long term cycling and a second plot line 602 that depicts the discharge capacity performance of a composite lithium metal battery subjected to the constant current protocol over long term cycling. Similarly, FIG. 7 illustrates a graph 700 that includes a first plot line 701 that depicts the capacity retention percentage performance of a composite lithium metal battery cell subjected to the disclosed sequence current charging protocol over long term cycling and a second plot line 702 that depicts the capacity retention percentage performance of a composite lithium metal battery subjected to the constant current protocol over long term cycling.

For the composite lithium metal battery cell, there was a difference of 15 mA/g in initial capacity when comparing the two charging methods/protocols. Past charging cycle number 340, the specific capacity for constant current (i.e., plot line 702) drops below that for the sequencing current (i.e., plot line 701). In FIG. 7, the capacity retention graph demonstrates that the capacity retention for the composite lithium metal battery cell subjected to the constant charging current steadily decreases beginning near charging cycle number 100 (see plot line 701). The rate of decreasing capacity for the battery cell increases substantially after the charging cycle number 300. In contrast, the composite lithium metal battery cell subjected to the sequence charging current retains nearly 100% of its initial capacity by the time the battery cell subjected to the constant charging current reaches its end-of-life. By cycle number 550, the composite lithium metal battery cell subjected to the sequence charging current still retains 95% of its initial capacity. In comparison with the bare lithium battery cell where no significant difference in performance was observed for the two current charging methods, FIGS. 6 and 7 collectively show the benefit of using the sequence charging current with composite lithium metal battery cells for increased retention and longer cycle life.

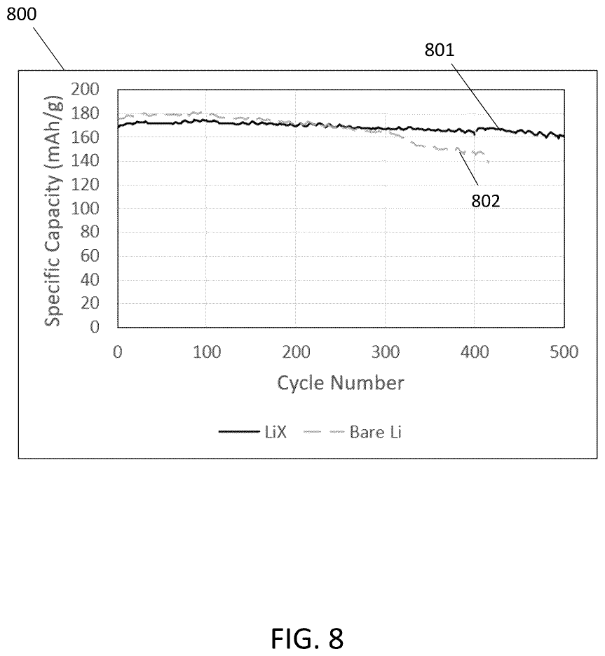

FIG. 8 illustrates the difference in long-term cycling performance for specific capacity (milliampere-hours per gram mass; mAh/g) between a bare lithium metal battery cell (i.e., a lithium-ion battery that includes a bare lithium metal anode) and a composite lithium metal battery cell (i.e., a lithium-ion battery that includes a composite lithium metal anode) using the disclosed sequence current charging protocol. In particular, graph 800 of FIG. 8 includes a plot line 801 depicting the specific capacity performance of the composite lithium metal battery cell and plot line 802 depicting the specific capacity performance of the bare lithium metal battery cell.

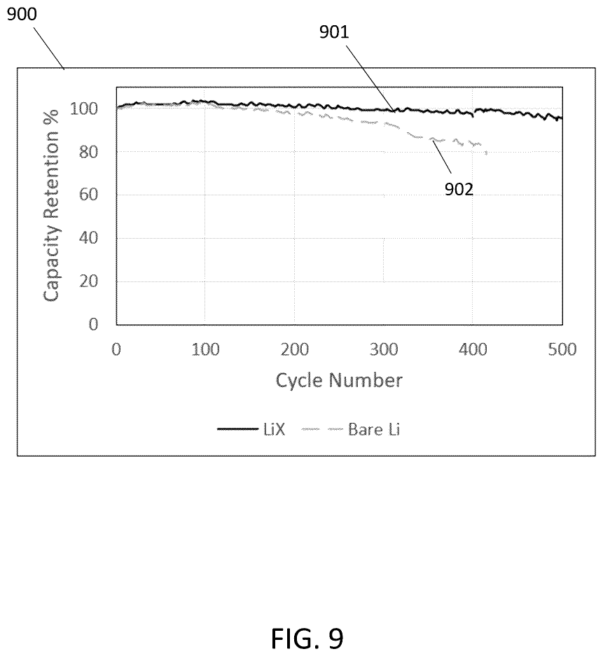

Similarly, FIG. 9 illustrates the difference in long-term cycling performance for capacity retention percentage (%) between a bare lithium metal battery cell and a composite lithium metal battery cell using the disclosed sequence current charging protocol. In particular, graph 800 of FIG. 9 includes a plot line 901 depicting the capacity retention performance of the composite lithium metal battery cell and plot line 902 depicting the capacity retention performance of the bare lithium metal battery cell.

Referring to FIG. 9, there is a significant difference in the capacity retention percentages when comparing the battery cells from early in the charge-discharge process to the latter stages of the charge-discharge process. Notably, the difference (i.e., graphical separation) between plot lines 901 and 902 grows more substantially past 300 charging cycles as the bare lithium metal battery cell reaches and end-of-life state and the composite lithium metal battery cell holds near its original 100% capacity. In FIG. 9, the bare lithium metal battery cell begins to drop below 99% retention at charging cycle number 171. In comparison, the composite lithium metal battery cell reached cycle number 430 before beginning to steadily drop from the level of 99% capacity retention. Notably, the composite lithium metal battery cell maintains this performance level for over an additional 250 cycles at nearly full capacity as compared to the bare lithium metal battery cell. The bare lithium metal battery cell reached end-of-life at cycle number 415, while at the same cycle the composite lithium metal battery cell was still at 99.1% retention. The composite lithium metal battery cell continued cycling past this point for over 100 additional cycles and still held approximately 95% capacity by cycle number 550.

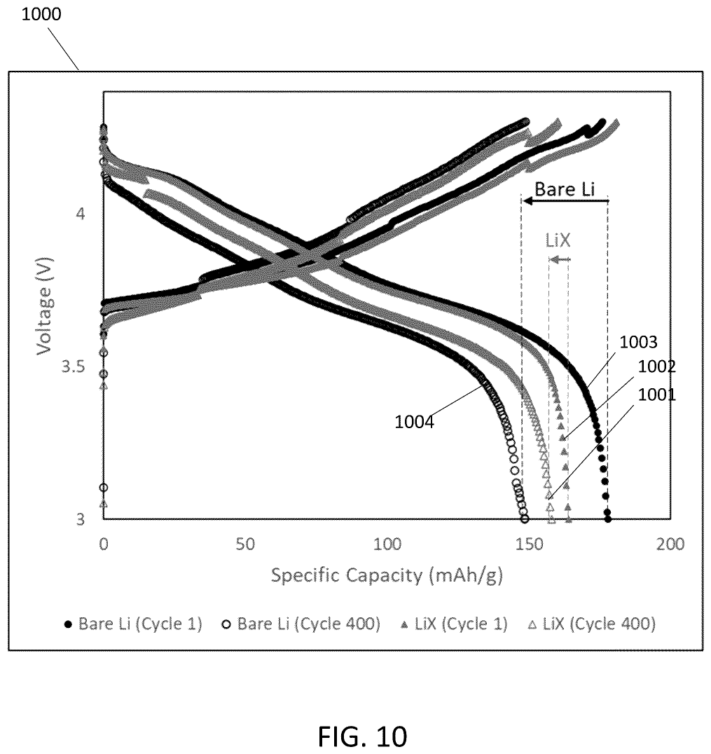

FIG. 10 depicts a graph 1000 illustrating the charge-discharge voltage profiles for a composite lithium metal battery cell and a bare lithium metal battery cell that are subjected to the disclosed sequence current charging protocol. Notably, graph 1000 illustrates the difference in charge and discharge capacities exhibited at cycle number 1 and cycle number 400 for both the composite lithium metal battery cell (plot lines 1001 and 1002) and the bare lithium metal battery cell (i.e., plot lines 1003 and 1004) under sequence current charging. Graph 900 further demonstrates the change in specific capacity after cycling. FIG. 10 specifically shows that plot lines 1001 and 1002 (composite) are grouped closer together as compared to the spacing between plot lines 1003 and 1004 (bare metal). Notably, the closer spacing between plot lines 1001 and 1002 supports the notion that the initial voltage profile of the composite lithium metal battery cell more closely resembles its voltage profile after 400 cycles (which is favorable/ideal) as compared to the bare lithium metal battery cell voltage profiles.

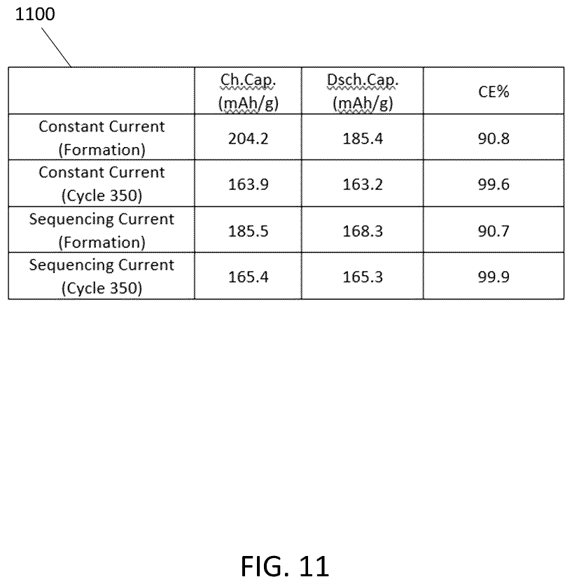

FIG. 11 depicts a table 1100 that summarizes the charge capacity (mAh/g), discharge capacity (mAh/g), and coulombic efficiency (%) after formation and 350 cycles for composite lithium metal battery cells that are tested using both charging current protocols. Notably, coulombic efficiency for charging current protocols was near 90% after formation, which is typical. Though there is a difference in the capacity values for composite lithium metal battery cells subjected to the two current charging protocols after cycling, both current charging protocols maintained high coulombic efficiency at high cycle numbers.

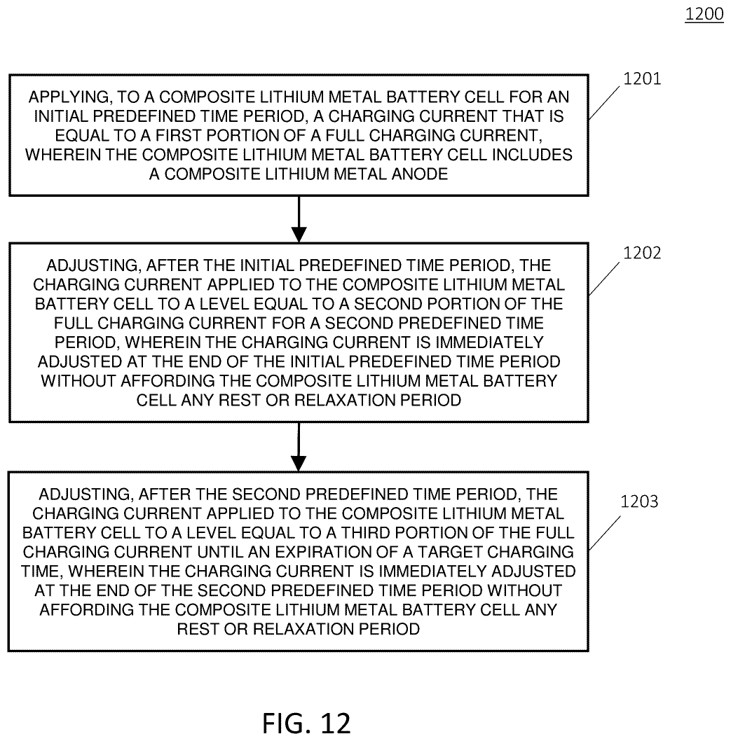

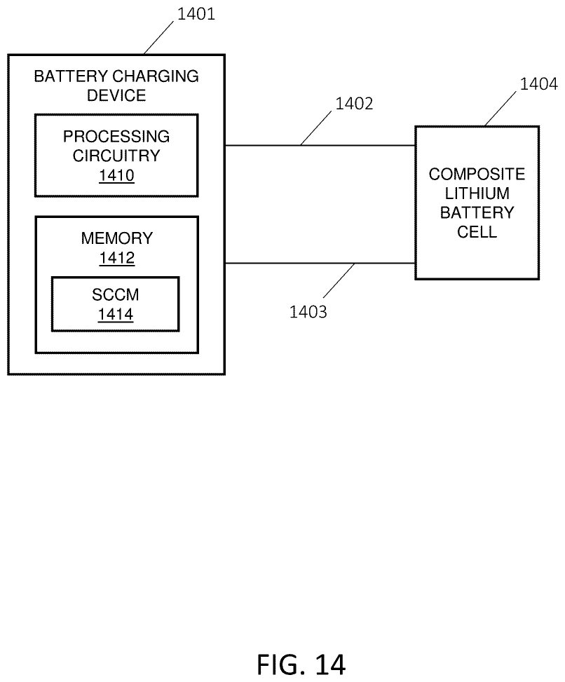

FIG. 12 depicts an exemplary method 1200 for sequence current charging a composite lithium metal battery cell. In some embodiments, method 1200 may be a software algorithm that is stored in memory and executed by one or more processors (e.g., processing circuitry) of a battery charging device (see, e.g., description for FIG. 14 below).

Step 1201 of method 1200 includes applying, to a composite lithium metal battery cell for an initial predefined time period, a charging current that is equal to a first portion of a full charging current. As used herein, a “first portion” may refer to a first fractional amount and/or a first percentage of the full charging current. Notably, the first potion can be any numerical value or amount that is less than the full charging current value (e.g., the first portion can be any percentage that is less than the 100% of the full charging current value, the first portion can be any fraction that is less than the unity (1.0) of the full charging current value). Further, as used herein, ‘full charging current’ refers to the amount of current corresponding to its one hour ‘C-Rate’ or ‘1 C’. In some embodiments, a sequence charging current of 0.5 mA that is equal to 50% of a full charging current (e.g., 1 mA) is applied to a composite lithium metal battery cell that includes a composite lithium metal anode. This current is applied for the duration of an initial predefined time period, such as 20 minutes. In some embodiments, the charging current equal to the first portion is a value within a range of one percent to 50 percent of the full charging current.

In some embodiments, the composite lithium metal battery cell comprises a battery cathode electrolyte and/or separator. The electrolyte may be at least one of: a liquid electrolyte solution, a solid material, or a semisolid material. Further, the semisolid material may comprise a polymer and/or a mixture of organic and inorganic materials. In some embodiments, the separator includes a polymer separator and/or a non-woven material separator.

In some embodiments, the liquid electrolyte solution comprises a lithium salt that includes at least one of an inorganic anion and/or an organic anion, wherein the inorganic anion is selected from the group of lithium perchlorate (LiClO₄), lithium tetrafluoroborate (LiBF₄), lithium hexafluorophosphate (LiPF₆), lithium hexafluoro-arsenate (LiAsF₆), lithium hexafluoroantimonate (LiSbF₆), lithium hexafluorotantalate (LiTaF₆), and lithium hexafluoroniobate (LiNbF₆), and the organic anion is selected from the group of lithium trifluoromethanesulfonate (LiCF₃SO₃), lithium perfluorobutylsulfonate (LiC₄F₉SO₃), lithium bis(trifluoromethanesulfonyl)imide (LiC₂F₆NO₄S₂), lithium bis (perfluoro-ethane-sulfonyl)imide (Li(CF₃CF₂SO₂)₂N), lithium tris(trifluoromethanesulfonyl) methide (C₄F₉LiO₆S₃), lithium pentafluoroethyltrifluoroborate (LiBF₃(C₂F₅)), lithium bis(oxalato)borate (LiB(C₂O₄)₂), lithium tetra(pentafluorophenyl)borate (C₂₄BF₂₀Li), lithium fluoroalkylphosphate (LiPF₃(CF₃CF₂)₃), lithium difluorophosphate, and lithium(difluorooxalato)borate. Step 1202 of method 1200 includes adjusting (e.g., increasing or decreasing), after the initial predefined time period, the charging current applied to the composite lithium metal battery cell to a level equal to a second portion of a full charging current for a second predefined time period. In some embodiments, adjusting the charging current after the initial predefined time period includes increasing the charging current or decreasing the charging current after the initial predefined time period. As used herein, a “second portion” may refer to a second fractional amount and/or a second percentage of the full charging current. Notably, the second portion can be any numerical value or amount that is less than the full charging current value (e.g., the second portion can be any percentage that is less than the 100% of the full charging current value, the first portion can be any fraction that is less than the unity (1.0) of the full charging current value. In some instances, the second portion is greater than the first portion (e.g., when the charging current is increased from a first fractional amount to a greater second fractional amount). However, this is not required and in some embodiments, the second portion is less than the first portion for situations where the sequence charging current is decreased from a first fractional amount to a lesser second fractional amount. In some embodiments, the charging current applied to the battery cell is increased to a charging level to 0.75 mA, which is equal to 75% of the full charging current. Notably, the charging current is immediately applied to the battery cell after the expiration of the initial predefined time period in a manner that does not allow the battery cell to experience a relaxation period or rest period (e.g., a pause from charging). This new charging current (e.g., increased charging current or decreased charging current) is applied to the battery cell for the duration of a second predefined time period, e.g., a second 20 minute time period. In some embodiments, the charging current equal to the second portion is a value within a range of 10 percent and 90 percent of the full charging current.

Step 1203 of method 1200 includes adjusting, after the second predefined time period, the charging current applied to the composite lithium metal battery cell to a level equal to a third portion of the full charging current until an expiration of a target charging time, wherein the charging current is immediately adjusted at the end of the second predefined time period without affording the composite lithium metal battery cell any rest or relaxation period. In some embodiments, adjusting the charging current after the second predefined time period includes increasing the charging current or decreasing the charging current after the second predefined time period. Notably, the third portion (as well as the first portion and/or the second portion) of the full charging current never exceeds 100% of the full charging current. In some embodiments, the charging current equal to the third portion is a value within a range of 20 percent and 100 percent of the full charging current.

In some other embodiments, after the second predefined time period, the charging current applied to the composite lithium metal battery cell is increased to a level equal to the full charging current (i.e., the third portion of the full charging current is equal to 100% of the full charging current) until an expiration of a target charging time. In some embodiments, the charging current applied to the battery cell is increased to the full charging level of 1 mA, which is equal to 100% of the full charging current. Notably, this full charging current is immediately applied to the battery cell after the expiration of the second predefined time period without allowing the battery cell to experience a relaxation period or rest period. The full charging current is applied to the battery cell for the duration of a third predefined time period, e.g., a third and final 20 minute time period. Although FIG. 12 depicts three sequence steps, additional steps can be implemented by without departing from the scope of the disclosed subject matter.

In some embodiments, the disclosed subject matter can be executed by a charging device or station configured to charge rechargeable lithium-ion batteries by delivering a regulated electrical current to one or more rechargeable battery cells, ensuring safe and efficient charging. Notably, the electrical current provided to the rechargeable battery cell (e.g., a composite lithium metal battery cell) is delivered in a manner consistent with the sequence current charging protocol described above. In some embodiments, the charging device or charging station is configured with a software algorithm or module (stored in memory of the charging device and executed by one or more processors) that includes the steps of FIG. 12.

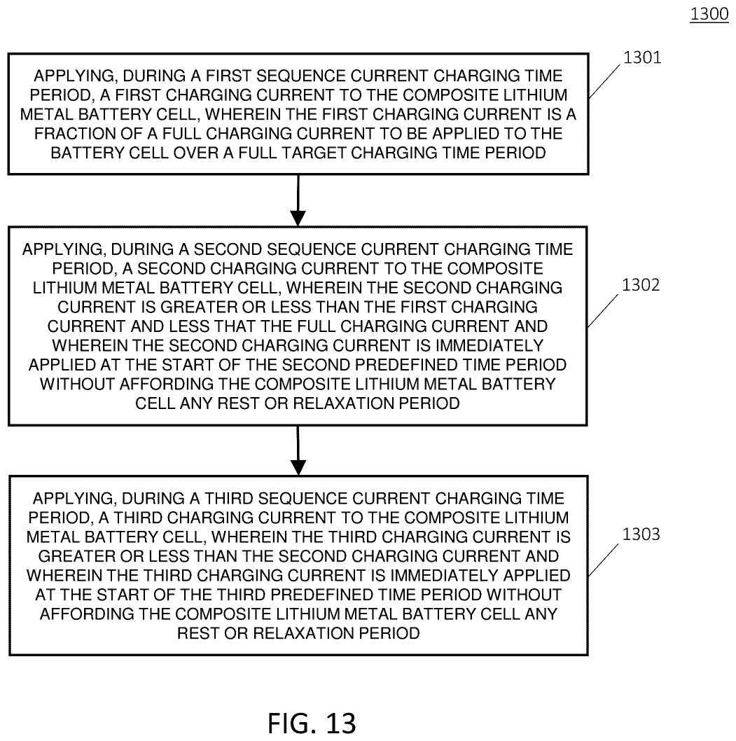

FIG. 13 depicts an exemplary method 1300 for sequence current charging a composite lithium metal battery cell. In some embodiments, method 1300 may be a software algorithm that is stored in memory and executed by one or more processors (e.g., processing circuitry) of a battery charging device (see, e.g., description for FIG. 14 below).

Step 1301 of method 1300 includes applying, during a first sequence current charging time period, a first charging current to the composite lithium metal battery cell, wherein the first charging current is a fraction of a full charging current to be applied to the battery cell over a full target charging time period, wherein the composite lithium metal battery cell includes a composite lithium metal anode. In some embodiments, the first charging current is equal to a value within a range of one percent to 50 percent of the full charging current.

In some embodiments, the composite lithium metal battery cell comprises a battery cathode electrolyte and/or separator. The electrolyte may be at least one of: a liquid electrolyte solution, a solid material, or a semisolid material. Further, the semisolid material may comprise a polymer and/or a mixture of organic and inorganic materials. In some embodiments, the separator includes a polymer separator and/or a non-woven material separator. In some embodiments, the liquid electrolyte solution comprises a lithium salt that includes at least one of an inorganic anion and/or an organic anion as indicated above with respect to FIG. 12.

Step 1302 of method 1300 includes applying, during a second sequence current charging time period, a second charging current to the composite lithium metal battery cell, wherein the second charging current is greater or less than the first charging current and less that the full charging current and wherein the second charging current is immediately applied at the start of the second predefined time period without affording the composite lithium metal battery cell any rest or relaxation period. In some embodiments, the second charging current is equal to a value within a range of 10 percent and 90 percent of the full charging current.

Step 1303 of method 1300 includes applying, during a third sequence current charging time period, a third charging current to the composite lithium metal battery cell, wherein the third charging current is greater or less than the second charging current and wherein the third charging current is immediately applied at the start of the third predefined time period without affording the composite lithium metal battery cell any rest or relaxation period. In some embodiments, the third charging current is equal to a value within a range of 20 percent and 100 percent of the full charging current. Although FIG. 13 depicts three sequence steps, additional steps can be implemented by without departing from the scope of the disclosed subject matter. In other embodiments, the third charging current is equal to 100 percent of the full charging current.

FIG. 14 is a block diagram of a battery charger device 1401 in accordance with various aspects described herein. In some embodiments, battery charger device 1401 may be any electrical charging device that is configured to supply a charging current to a rechargeable battery (such as a composite lithium metal battery cell). In other embodiments, battery charger device 1401 may be a rechargeable battery cycler testing device that is configured to charge and/or discharge a rechargeable battery. As used herein, the battery charger device 1401 may be or comprise various combinations hardware and/or software, including a standalone computing device. As shown in FIG. 14, battery charger device 1401 may be coupled (via one or more electrical connections 1402-1403) to a composite lithium metal battery cell 1404 that requires charging. As shown in FIG. 14, battery charger device 1401 may provide charging electricity to battery cell 1404 via an charging input connection 1402 and a charging output connection 1403. In some embodiments, the battery charger device 1401 includes processing circuitry 1410, a power source (not shown), and a memory 1412. Processing circuitry 1310 may include one or more processors, microprocessors, microcontrollers, and/or the like. The memory 1412 may be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and the like. Notably, memory 1412 is configured to store a sequence current charging manager (SCCM), which may include a software module and/or algorithm that when executed by the processing circuitry 1410 performs at least the operations of methods 1200 and/or 1300 described in FIGS. 12-13.

The embodiments shown and described in the preceding description are for illustration 10 and explanation only and are not intended to limit the scope of the disclosed subject matter recited in the appended claims.

What is claimed is:

1. A method for sequence current charging a composite lithium metal battery cell, the method comprising:
applying, to a composite lithium metal battery cell for an initial predefined time period, a charging current that is equal to a first portion of a full charging current, wherein the composite lithium metal battery cell includes a composite lithium metal anode;
adjusting, after the initial predefined time period, the charging current applied to the composite lithium metal battery cell to a level equal to a second portion of the full charging current for a second predefined time period, wherein the charging current is immediately adjusted at an end of the initial predefined time period without affording the composite lithium metal battery cell any rest or relaxation period; and
adjusting, after the second predefined time period, the charging current applied to the composite lithium metal battery cell to a level equal to a third portion of the full charging current until an expiration of a target charging time, wherein the charging current is immediately adjusted at an end of the second predefined time period without affording the composite lithium metal battery cell any rest or relaxation period.

2. The method of claim 1 wherein the composite lithium metal battery cell comprises a battery cathode electrolyte and/or separator.

3. The method of claim 2 wherein the electrolyte is at least one of: a liquid electrolyte solution, a solid material, or a semisolid material.

4. The method of claim 3 wherein the semisolid material comprises a polymer and/or a mixture of organic and inorganic materials.

5. The method of claim 2 wherein the separator includes a polymer separator and/or a non-woven material separator.

6. The method of claim 1 wherein adjusting the charging current after the initial predefined time period includes increasing the charging current or decreasing the charging current after the initial predefined time period.

7. The method of claim 6 wherein adjusting the charging current after the second predefined time period includes increasing the charging current or decreasing the charging current after the second predefined time period.

8. The method of claim 3 wherein the liquid electrolyte solution comprise a lithium salt that includes at least one of an inorganic anion and/or an organic anion, wherein the inorganic anion is selected from the group of lithium perchlorate (LiClO₄), lithium tetrafluoroborate (LiBF₄), lithium hexafluorophosphate (LiPF₆), lithium hexafluoro-arsenate (LiAsF₆), lithium hexafluoroantimonate (LiSbF₆), lithium hexafluorotantalate (LiTaF₆), and lithium hexafluoroniobate (LiNbF₆), and the organic anion is selected from the group of lithium trifluoromethanesulfonate (LiCF₃SO₃), lithium perfluorobutylsulfonate (LiC₄F₉SO₃), lithium bis(trifluoromethanesulfonyl)imide (LiC₂F₆NO₄S₂), lithium bis (perfluoro-ethane-sulfonyl)imide (Li(CF₃CF₂SO₂)₂N), lithium tris(trifluoromethanesulfonyl) methide (C₄F₉LiO₆S₃), lithium pentafluoroethyltrifluoroborate (LiBF₃(C₂F₅)), lithium bis(oxalato)borate (LiB(C₂O₄)₂), lithium tetra(pentafluorophenyl)borate (C₂₄BF₂₀Li), lithium fluoroalkylphosphate (LiPF₃(CF₃CF₂)₃), lithium difluorophosphate, and lithium(difluorooxalato)borate.

9. The method of claim 1 wherein the third portion of the full charging current is equal to 100% of the full charging current.

10. The method of claim 1 wherein the charging current equal to the first portion is a value within a range of one percent to 50 percent of the full charging current.

11. The method of claim 10 wherein the charging current equal to the second portion is a value within a range of 10 percent and 90 percent of the full charging current.

12. The method of claim 11 wherein the charging current equal to the third portion is a value within a range of 20 percent and 100 percent of the full charging.

13. A method for sequence current charging a composite lithium metal battery cell, the method comprising:
applying, during a first sequence current charging time period, a first charging current to the composite lithium metal battery cell, wherein the first charging current is a portion of a full charging current to be applied to the battery cell over a full target charging time period, wherein the composite lithium metal battery cell includes a composite lithium metal anode;
applying, during a second sequence current charging time period, a second charging current to the composite lithium metal battery cell, wherein the second charging current is greater or less than the first charging current and less that the full charging current and wherein the second charging current is immediately applied at the start of the second predefined time period without affording the composite lithium metal battery cell any rest or relaxation period; and
applying, during a third sequence current charging time period, a third charging current to the composite lithium metal battery cell, wherein the third charging current is greater or less than the second charging current and wherein the third charging current is immediately applied at the start of the third predefined time period without affording the composite lithium metal battery cell any rest or relaxation period.

14. The method of claim 13 wherein the composite lithium metal battery cell comprises a battery cathode electrolyte and/or separator.

15. The method of claim 14 wherein the electrolyte material is at least one of: a liquid electrolyte solution, a solid material, or a semisolid material.

16. The method of claim 13 wherein the first charging current is equal to the full charging current.

17. The method of claim 13 wherein the second charging current is a value within a range of 1 percent to 50 percent of the full charging current.

18. The method of claim 17 wherein the third charging current is a value within a range of 10 percent and 90 percent of the full charging current.

19. The method of claim 18 wherein the charging current equal to the third portion is a value within a range of 20 percent and 100 percent of the full charging current.

20. A battery charger device that is configured to apply a charging current to a composite lithium metal battery cell, the device comprising:
processing circuitry; and
a memory coupled to the processing circuitry, wherein the memory comprises computer readable program instructions that, when executed by the processing circuitry, cause the control system to perform operations to:
apply, during a first sequence current charging time period, a first charging current to the composite lithium metal battery cell, wherein the first charging current is a fraction of a full charging current to be applied to the battery cell over a full target charging time period, wherein the composite lithium metal battery cell includes a composite lithium metal anode;
apply, during a second sequence current charging time period, a second charging current to the composite lithium metal battery cell, wherein the second charging current is greater or less than the first charging current and less that the full charging current and wherein the second charging current is immediately applied at the start of the second predefined time period without affording the composite lithium metal battery cell any rest or relaxation period; and
apply, during a third sequence current charging time period, a third charging current to the composite lithium metal battery cell, wherein the third charging current is greater or less than the second charging current and wherein the third charging current is immediately applied at the start of the third predefined time period without affording the composite lithium metal battery cell any rest or relaxation period.
